(19) United States
(12) Patent Application Publication
(10) Pub. No.: US 2009/0051485 A1
(43) Pub. Date: Feb. 26, 2009

(54) Methods and Apparatus for Product Authentication

(75) Inventors: John Joseph Corry, Cheadle (GB); David Leslie McNeight, Wilmslow (GB)

Correspondence Address: ROBERTS, MARDULA & WERTHEIM, LLC, 11800 SUNRISE VALLEY DRIVE, SUITE 1000, RESTON, VA, 20191, US

(73) Assignee: ADVANCED ANALYSIS AND INTEGRATION LIMITED, Manchester (GB)

(21) Appl. No.: 10/592,301

(22) PCT Filed: Mar. 9, 2005
(86) PCT No.: PCT/GB2005/000913

§ 371 Date: Sep. 4, 2008

(30) Foreign Application Priority Data
Mar. 10, 2004 (GB) GB 0405365.8

(51) Int. Cl. H04Q 1/00

(52) U.S. Cl. 340/5.8

(57) ABSTRACT

A method for product authentication, comprising applying to the genuine products code on a label, the code being generated by an algorithm, which code is unique to a small sub-set of articles, preferably for a single such article, so that it can be assumed that any product on the market which either does not have a label or has a wrong label, or for which the label is otherwise accounted for, is counterfeit, the label being machine readable, such as a writeable RFID tag characterised in that the label comprises a machine-readable microcircuit to which a code can be written, and from which the written code can be read remotely.

This invention relates to method and apparatus for product authentication.

There are numerous reasons for requiring product authentication. One reason is for the prevention of counterfeiting. Another is to detect stolen goods that have appeared on the market.

Many products are counterfeited, and many methods have been tried, usually quite unsuccessfully, to detect spurious goods and prevent further infringement. When a product is seriously counterfeited, the market in the counterfeit goods can be a very significant proportion of the whole market for goods of that description, often more than 50%. Goods which are counterfeited on a very regular and widespread basis include up-market brands of watches, Scotch whisky, currency notes and other documents such as tickets to important sporting events, clothing, automotive and aero spare parts, and even medical items such as heart valves.

Very often, the goods are manufactured to standards at least as high as those of the genuine articles. In such cases, the eventual purchaser may not have suffered greatly, but the manufacturer has lost valuable sales. In some cases, the spurious goods are identical to the genuine goods, and are, indeed, made by the same manufacturer—this happens when a manufacturer sub-contracts the supply of, say, 20,000 pairs of jeans. In the modern world, sub-contracts are awarded to manufacturers in far-flung places, where labour costs are significantly lower than in the manufacturer's home territory. All too often, the sub-contractor will turn out 20,000 pairs for a local distributor, 20,000 pairs for himself, and only then get around to making up the original order This is, indeed, such a commonplace practice that it is regarded in much the same way as shoplifting, namely a problem that has to be tolerated. Yet it means that the manufacturer is losing two thirds of his potential business.

To differentiate genuine goods from counterfeit goods, especially in the case of production overruns, where the goods are identical, resort must be had to labelling genuine goods. However, a label is only another item capable of being counterfeited. Attempts to deter counterfeiters by making expensive, difficult-to-copy labels do not work, as it is well worth the counterfeiter's effort to produce a fake label which is an exact copy of the original. If the counterfeiter produces more goods than the genuine manufacturer, he may well get his labels cheaper!

This problem was addressed in U.S. Pat. No. 4,463,250 and, to some extent, for documents, in EP 0006498, the solution being to assign to each and every product a unique code, for example a number, exactly as is done with currency notes, but to arrange that the numbers are not serial numbers. For example, serial numbers might have added check digits, so that only one in every hundred numbers would be a genuine product number. The check digits would be generated by an algorithm.

The code could be applied to a product as, for example, a bar code, which could be read by a bar code reader equipped with a computing arrangement that “knew” the algorithm and could check that any code it read was genuine, i.e. conformed to the algorithm, or not. Any product that either did not have a code or that had a “wrong” code would be assumed not to be genuine.

That leaves the possibility that a counterfeiter will purchase a genuine product and simply copy the code, which will, of course, pass the test when read. So the bar code reader is also programmed to detect whether it has previously seen any particular code—it simply stores in memory the codes it has read, and checks each newly read code that passes the test against what is in its memory.

Now, in order to defeat this detection method, the counterfeiter has to purchase a lot of products, or somehow or other get hold of a lot of genuine codes, and copy them, ensuring that each batch of products he sends out will not contain two codes the same. The algorithm can, of course, be made quite complex so that it would be impossible to crack the codes from any reasonable number of known genuine codes.

Since even the acquisition of a large number of genuine codes in order to defeat the anti-counterfeiting measure is not out of the question, U.S. Pat. No. 4,462,250 provided that codes read by the code reader should be downloaded into a central computer which would store all the codes read by all the code readers in operation. The central computer would then pick up duplicates, and, knowing the location where such codes were read, would lead to the source of the problem.

The method, however, clearly had logistical problems. Though it did not need specialist inspectors, trained to spot minute differences in product or label, and though it was possible to examine a row of jeans, say, in a few minutes by running a bar code reader over the label on each pair, this was in itself a problem, as retailers, who are often “in on the game” would not be inclined to permit such activity, as they are quite possibly joint tortfeasors with the counterfeit manufacturer, and, most often, the goods were not even so readily accessible. Moreover, the method assumes that codes will be read only once, whereas, particularly in the case of currency notes, the same note might pass several times through a bank in a week and be read each time, throwing up a lot of spurious counterfeit indications.

Nevertheless, the system, in its overall concept, is the only system that will detect counterfeit labels, even if they are identical to genuine labels.

The present invention provides means by which the system above outlined can be put into effect with no or minimal logistical problems, as well as means to extend the utility of the system.

The invention, in one aspect, comprises a method for product authentication, comprising applying to genuine products a code on a label, the code being generated by an algorithm, which code is unique to a small subset of articles, preferably to a single such article, so that it can be assumed that any product on the market which either does not have a label or has a wrong label, or for which the label is otherwise accounted for, is counterfeit, the label being machine-readable, characterised in that the label comprises a machine-readable microcircuit, to which a code can be written, and from which the written code can be read remotely.

By ‘remotely’ is meant at a distance appropriate for covert reading of the label. Different situations will call for different distances. Generally, a distance of from one to several metres will be all that is required, so that goods in stores, perhaps on shelves, can be dealt with.

Microcircuits can be machine-interrogated, by transmitting a radio frequency coded message, which causes the microcircuit to transmit a response. If, as will often be the case, numerous labels are within range of an interrogating-message, the responses can be separated in the frequency domain or the time domain, each label having, for example, a unique response time. If the radio frequency is in the megahertz region of the radio spectrum, hundreds or even thousands of labels can be interrogated within the space of a few seconds.

While the system can clearly be used to very good effect to detect counterfeit goods, it can also be used for routine tasks, such for example, as stock or inventory control. A problem is experienced, for example, in warehouses and supermarkets, where ‘goods in’ checks need to be undertaken to ensure that what is set out on the delivery manifest is, in fact, received. This involves opening bulk packs and logging their contents. Even if the products are bar-coded, they must be put on to a belt to be run through a reader. Often, this takes so much time that the checks are not carried out, and supermarkets often notice, too late to do anything about it, a disparity of up to 10% between what they have and what they should have, which not only represents a direct loss of revenue, but also an indirect loss inasmuch as stock controls, on which such establishments rely for their smooth running, are unreliable, so that stock is not ordered on time and shelves are empty.

A problem of comparable importance to counterfeiting is that of theft. Vans and trucks carrying expensive loads of high value goods such as wines and spirits are often hi-jacked. Their contents can be split up for delivery to local retail outlets, such as public houses and off-licences, or they can be ferried to a different country. As the individual items—the bottles of wine or spirits—will each have a uniquely coded label, or as small numbers of them only will have any one code, they will be identifiable as being stolen goods. It is even possible that such goods can be detected in transit, without an inspector even boarding a van or truck. To facilitate such inspection, it may be that wholesale packs, such as cases of a dozen bottles, can have a coded label as well as or in addition to labels on the individual bottles themselves, so that a truckload of such cases is rapidly scanned. This would enable trucks to be intercepted at customs points or while loading on to a ferry, details of the codes being flashed to such locations. The interrogating data readers can even be programmed remotely.

The codes can, of course, contain information about the nature of the product, as well as about sell-by dates. Moreover, product leaving a manufacturer for, say, a distributor, can be tagged as ‘in transit’, with an indication of the source and destination. The distributor can check readily then whether goods actually received are goods intended for a particular depot. On receipt, the goods can be re-tagged as being in store. Receipt can trigger a message to the source that the goods have been well received. Likewise as between a distributor and a retailer. There can thus be a check on the goods at each stage in the distribution chain. While this may be of considerable importance simply from the point of view of good management, it can also throw up, or hopefully deter, such practices as diversion of goods intended for specific markets, conforming, for example, to voltage or radiation emission standards, language, trademark rights and customs and excise duties.

Goods such as wines and spirits, on which duty is payable, can be labelled with no possibility of counterfeiting, with a Government ‘stamp’ on a tag, as they leave a bonded warehouse, the tagging operation being automatically logged on a Government database from which duties payable by a distillery, for example, are automatically calculated and credited to the Government's account.

Currency notes can be coded with their face value, so that they can be automatically counted. At present, automatic counting involves placing a wad of notes in a note feeder, where they are counted by being picked off one by one, but it must be ensured that all notes are of the same denomination. Using labelled notes according to the invention, it would be possible to count a mixed wad of notes, value them and authenticate them in one pass, and even to sort them automatically into their respective denominations.

Actually, a wad of notes could be scanned as such, without picking off individual notes, using frequency or time domain separation of responses, but since a note without any label at all would give no response, it would be necessary to have another means of telling whether any such note was in the wad. This could be done by measuring the thickness of the wad, or its weight. A similar consideration applies more generally, of course—it is necessary to know how many responses should be received, in order to determine whether any particular item is without a label, indicating that it is spurious, the counterfeiter not even having bothered to counterfeit the labelling. If this cannot be determined by visual inspection, as by noting how many bottles of spirits, for example, are displayed on a shelf, or if it is not a ‘given’, as by a delivery note or loading manifest, it would be necessary to devise some way, which might be peculiar to any given circumstance, to determine whether there are any unlabelled goods.

This problem, where it is a problem, can, however, be dealt with by appointing retail outlets as inspectors, checking that goods received have appropriate labelling before placing them on shelves, and, to this end, might be supplied with a microcircuit interrogator, communicating the codes to a central computer for verification before signing off for the receipt. In order to encourage retailers not to accept counterfeit or stolen goods, there could be a substantial reward for information and, of course, the prospect of prosecution otherwise.

The invention, in another aspect, comprises apparatus for product authentication, comprising a set of labels, each bearing a code, the code being generated by an algorithm, which code is unique to a small subset of labels, preferably to a single such label, so that it can be assumed that any product on the market which either does not have a label or has a wrong label, or for which the label is otherwise accounted for, is counterfeit, the labels being machine-readable, characterised in that each label comprises a machine-readable microcircuit, to which its code is written, and from which the written code can be read remotely, and machine code-reading means by which the codes can be read remotely for the purpose of authenticating a product to which one of the labels is applied.

The label may comprise a microcircuit which can be interrogated by a signal from the code-reading means eliciting a response which is received by the code-reading means, the response comprising data comprising the code.

The code-reading means may comprise logic circuitry adapted to analyse the received code to verify it as being a code which is proper to the product bearing the label. The code-reading means may comprise memory means adapted to store a plurality of received codes. The stored received codes may be verified codes and/or codes determined to be wrong codes.

The code-reading means may be downloadable so that received codes can be transferred to a central computer from a plurality of such machine code-reading means. The code-reading means and/or the central computer may be programmed to check for duplicate codes. This check may be carried out in real time, and a signal sent to any code-reading means that has reported a duplicate code, so that a potential infringement may be investigated on the sport before ‘evidence’ is sold. Communication between code-reading means and central computer may be for example by a cellular or satellite telephone system.

The invention also comprises a method for product authentication, comprising applying to genuine products a code on a label, the code being generated by an algorithm, which code is unique to a small subset of articles, preferably to a single such article, so that it can be assumed that any product on the market which either does not have a label or has a wrong label, or for which the label is otherwise accounted for, is counterfeit, the label being machine-readable, characterised in that the label can be changed when it is machine-read.

Thus, in the case of currency notes, for example, a counter in the label can be incremented each time the label is machine-read. In the case of goods, the label can be changed as the goods pass through stages of the supply chain. The arrangement may be such that a code written to a label can be overwritten with a different code. This can be used to track goods through the marketing process. Thus, goods leaving the manufacturer's premises for a distribution centre may be assigned one type of code. At the distribution centre they may have a different code substituted, and, again, at the retail outlet, yet a third code can be substituted. The code which is actually on goods at the point of retail sale can help indicate at what stage an irregularity in the supply chain has occurred.

Methods and apparatus for product authentication according to the invention will now be described with reference to the accompanying drawings, in which:

FIG. 1 shows a series of labels bearing microcircuits with written-in codes;

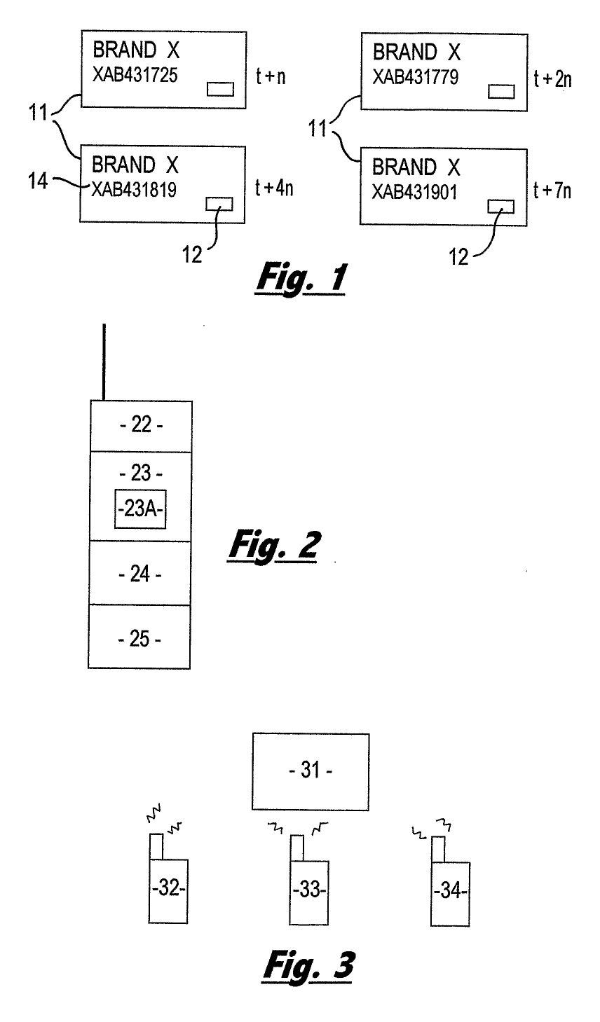

FIG. 2 shows a machine code-reader interrogating a series of labels;

FIG. 3 shows a series of machine code-readers reporting to a central computer which is, in turn, signalling one of the readers to the effect that a duplicate code has been detected;

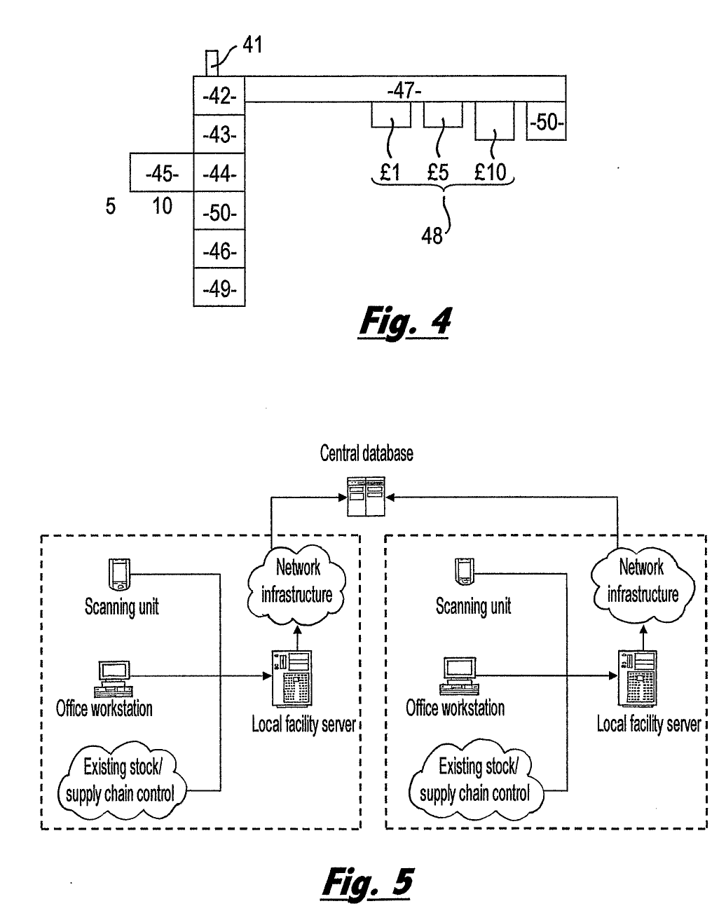

FIG. 4 illustrates a currency note authenticating, valuing and sorting arrangement;

FIG. 5 illustrates full tracking of every item produced by a manufacturer through the supply chain to retail outlets; and

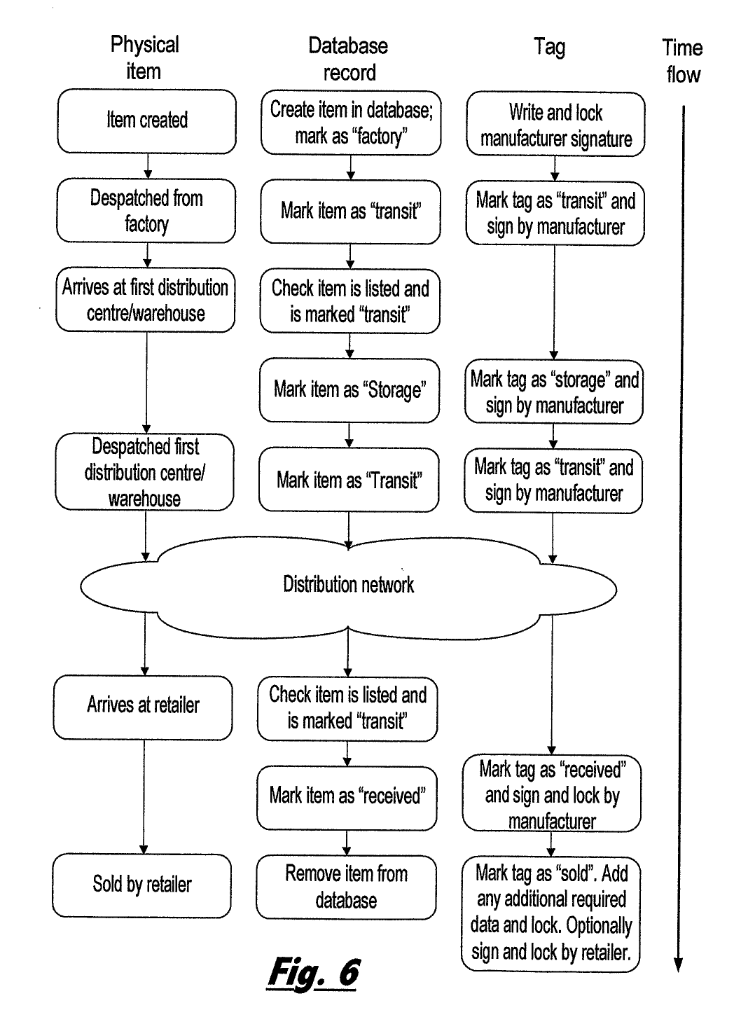

FIG. 6 illustrates a typical supply chain and the database and tag status at the various stages thereof.

The drawings illustrate methods and apparatus for product authentication. Broadly, the methods comprise applying to genuine products a code on a label 11, the code being generated by an algorithm, which code is unique to a small subset of articles, preferably to a single such article, so that it can be assumed that any product on the market which either does not have a label or has a wrong label, or for which the label is otherwise accounted for, is counterfeit, the label 11 being machine-readable, characterised in that the label 11 comprises a machine-readable microcircuit 12, to which a code can be written, and from which the written code can be read remotely. Machine readable and writable tags are commercially available, and are, in fact, used for stock control purposes and for tagging high value products in retail stores, so that, unless the tag is removed, or cancelled, it will activate an alarm on passing a sensor located at the door of the retail establishment. These tags are usually uniquely identified with a ‘burnt-in’ number by the tag manufacturer—the number can, for example, be a 64 bit binary number. While such a number could serve as the unique code for present purposes, it would be necessary to go through an expensive look-up process each time it was read in order to verify that it was a genuine code. It would be possible to know the manufacturer's method for number selection, if the manufacturer's numbers were not serial numbers, but this would defeat the object of the exercise, as a counterfeiter could simply buy tags from the same manufacturer, and they would appear to be attached to genuine products. However, according to the invention, such a manufacturer's number would be used as input to an algorithm to generate another number which is inserted into a vacant memory slot on the tag—there are usually several writable slots available, into any one or more of which a code can be burnt so that it cannot be changed.

Knowledge of the algorithm, then, can be used to check whether the written-in code is properly derived from the tag manufacturer's number, or from another number, such as a serial number applied by the product manufacturer, identifying a genuine article. Reading the same code over and over indicates that a counterfeiter has merely copied one tag many times.

But if, as in the case of currency notes, the same article is likely to be checked more than once, repeated reading of the same code would give a spurious indication of counterfeiting. In this case, another memory slot on the tag can be used as a counter, being incremented each time the tag is interrogated. The memory capacity of the tags is such that, in addition to a simple incrementing counter, information can be inserted as to which machine reader/writer was involved in the interrogation and its location at the time, for example by means of the bank sort code or a code assigned to a machine in a currency exchange or retail establishment, so that information can be gleaned, for example, about the circulation of each currency note, and even, perhaps, indicate that it is coming to the end of its useful life and should be withdrawn from circulation. Such information can have an obvious relevance to measures combating money laundering.

The labels 11, as seen in FIG. 1, will be of any desired form, as is conventional for different products. They may, for instance, be swing tags or tickets, or printed wrappers, or printing on boxes or cartons, or they may be printed directly on to an article. Microcircuits 12 can be incorporated in any conventional way. Codes 14, shown as alphanumeric codes, can, if desired, be printed on to the labels 11 but in any event are written in to the microcircuits which can be interrogated by a signal to broadcast a response including the code appropriate to that particular label 11.

The codes 14 are generated by an algorithm, usually of some complexity, so that knowledge even of quite a large number of individual codes cannot yield any hope of guessing the algorithm. Generally, unless a tag manufacturer's burnt-in number is used as the basis for the code, the algorithm will take a serial number and generate check digits or letters which will be added to the serial number, not necessarily at the end, nor even in adjacent locations. The check digits in the codes shown in FIG. 1, for example, could be the fifth and ninth characters. While this may well be an adequate deterrent, encryption may be carried out according to the established PGP system, which uses a public/private key pair system in which the private key encrypts messages so that they can then be decrypted using a public key. The public key may be distributed only to the intended recipient of the data, or may even be made truly public, so that anyone can decrypt the message, but it is nevertheless guaranteed that what is decrypted has not been tampered with.

As space on currently available tags is considerable, but limited, in order to allow space for additional information, the PGP system can be used to create a small ‘signature’ of the data to be protected. The data can be based on the tag manufacturer's tag serial number or on a number based on that number but with an added code (which may be as simple as the date, even, perhaps, just the four digit year of manufacture) to counter the risk that tag manufacturers could repeat batches of tag numbers.

FIG. 2 illustrates an interrogating machine code reader 21, comprising an RF section 22 that sends an interrogating signal to the plurality of labels 11, shown in FIG. 1, for clarity's sake, as such, rather than, as would ordinarily be the case, applied to products. The labels may arranged, inherently with their coding, to respond at different times, indicated as t+n, t+2n, t+7n and so forth, where t is a base time delay and n is a given increment in microseconds. In this way, the responses can be picked up as separate messages by the RF section 22 and fed to a logic section 23, which ascertains whether they conform to the algorithm that generated the codes on the labels. If any code does not so conform, a message to that effect is displayed on a visual display unit 23A, and an audible alarm may also be raised. The spurious code will be displayed, or so much of it as is necessary for the identification of the label in question—if more than one spurious label is encountered, the codes can be displayed serially. However, instead of building in delays, the interrogating machine could simply pick whatever signal reached it first after any interrogatory burst, and simply fire bursts until all the labels had been read.

Received codes are passed into a memory section 24. As each new code is read, it is compared with the codes currently stored in the memory section to check for duplicate codes. If any such is found, the duplicated code will, again, be displayed in the display unit 23A, with or without an audible alarm, perhaps a different alarm sound to the spurious code alarm.

The on-the-spot action to be taken on detection of a spurious or duplicated code will depend on the circumstances, but in any event, data stored in the memory section 24 can be transmitted, either as soon as an inspection is completed, or later on, after, perhaps, collection of data from a number of sites, by a communication section 25 to a central computer 31, FIG. 3, possibly via a cellular telephone network or a satellite telephone or, indeed, in any other convenient way, where codes received from multiple readers 32, 33, 34 etc. which may be deployed in different cities or even countries. In the central computer 31, codes can be checked on a global basis for duplicated codes, and other processing can take place which can yield valuable information for use by sales and marketing analysts, and which can reveal the whereabouts of goods that have been stolen or marketed in areas other than those for which they were intended. Where an incrementing counter is provided in the memory section, this will be checked to ensure that a second or third reading of the label does not trigger an alarm.

FIG. 4 illustrates equipment for sorting, counting and verifying currency notes, of which a wad, 41, is loaded into a note feeder 42, from where they are counted off one by one into a code reader 43, which has a logic section 44 and a memory section 45, having the same purposes as the equivalent components of the equipment of FIG. 3. A denomination checker 46 signals a sorter 47 to sort the notes into separate piles 48 according to their denominations, while a visual display unit 49 displays the total amount counted, the total genuine note value counted, corresponding amounts for each denomination, and details of any spurious notes, cast into a counterfeit pile 50.

A wad of notes could be interrogated without passing through a counter one by one. The problem here is that if a note has no label, it will not be counted, and give no indication that it is there, so that spurious notes could survive the operation. However, a wad of notes can be weighed, or have its thickness measured, or both, to indicate how many there are in the wad, and, if the electronic count delivers a lower value, it can be assumed that this is due to the presence of a non-responsive note or notes, which may be counterfeit, and the wad mote closely inspected.

FIGS. 5 and 6 illustrate control through a supply chain. FIG. 5 shows the basic system requirements. At each distribution centre or retail establishment 51 is a scanning unit 52, which scans goods inward tags, and, if appropriate, modifies the information on the tags. This operation is controlled by an office workstation 53, which also receives the codes read by the scanning unit 52 and interfaces with any existing stock or supply chain control system 54. Several such systems can report to and receive information from a local facility server which interfaces with network infrastructure, which, in turn, is connected to a central database 55. Such an arrangement can be operated in different ways. For instance, the control of the entire network can be effected from the central database 55, or control can be delegated to local facility servers, using the central database to check for repeated codes evidencing counterfeiting.

Scanning units will be different in different establishments. A unit for bulk scanning of palletised goods, for example, will comprise a gate or tunnel through which the pallet is carried fitted with an array of sensor/writers placed so as to be certain to access all tags within the palletised load, no matter what their orientation. A small retail establishment will normally rely on a counter-top device or even a hand held device, rather like the credit card readers used in restaurants.

FIG. 6 shows a typical chain of events from manufacture to retail sale of an item.

When an item is created, it is assigned a code created in a database and marked as ‘factory’. The code is written to a tag and at least the manufacturer's ‘signature’ is locked.

When the item is despatched from the factory, it is marked as being in transit, the ‘factory’ indication being overwritten, and this change in recorded in the database. On arrival at the intended destination, a distribution centre or warehouse, it is checked to ensure that it is listed as being expected, and that it is marked ‘transit’. The marking is changed from ‘transit’ to ‘storage’, both in the database and on the tag, which is ‘signed’ by the manufacturer, sending instruction therefor over the network.

When the item is sent from the distribution centre or warehouse, it is marked ‘transit’ again, both in the database and on the tag, which is again ‘signed’ by the manufacturer. This may happen several times as the item passes through a distribution network.

Eventually, it arrives at a retailer, where it is again checked to see that it is expected and that it is marked ‘transit’. The database is changed to mark the item as ‘received’, and the tag is also so marked and signed by the manufacturer. This last change will be locked on the tag by the manufacturer. When the item is sold by the retailer, it is removed from the database and the tag is marked as ‘sold’. Additional data may be added and locked, rendering the tag void for further transactions.

Many variations can be devised all falling within the scope of the general method and apparatus, and the method and apparatus are sufficiently flexible in concept to cater for a very wide range of products.

Thus, in addition to anti-counterfeiting codes, useful information about the manufacturer, the date of manufacture, the intended destination and so forth can all be entered into the memory of sufficiently smart labels, and changed from time to time as might be appropriate. Manufacturers will be able to establish when goods intended for one market have found their way into a different market, which might involve some violation of licences or tax or duty fraud, and goods which have been stolen can be located, which can lead to the detection of those responsible by backtracking through a chain of supply, and provide an audit trail useful in legal or criminal proceedings thereafter.

Counterfeit-proof customs and excise labels can be applied, simply as part of an anti-counterfeiting measure protecting the manufacturer against copyists and product diversion and protecting the public against the sale of spurious goods which often are of inferior quality despite being outwardly deceivingly similar to genuine goods.

The facility for supply chain monitoring can give early warning of theft of trucks and containers and can identify stolen goods when they appear in retail establishments. Hand held devices can be used to inspect retail premises, market stalls, car boot sales and other places where spurious or stolen goods might be displayed for sale, and retailers can be supplied with equipment that enables them to identify such goods when received on their premises.

Counterfeiting is often dealt with, once detected, by attacking the manufacturer. But where a retailer has the facility to check goods inwards before accepting them, it becomes possible to prosecute the retailer found with stolen or spurious goods, and this facility will severely restrict the ability of the counterfeiter to dispose of his products, which will render the practice uneconomic.

1-24. (canceled)

25. A method for product authentication comprising:
applying a product tag to a product, wherein the product tag comprises a memory slot for receiving a generated code;
generating the generated code by applying an algorithm applied to a code basis;
storing the generated code in the memory slot of the product tag;
transmitting an interrogation signal to the product tag;
receiving a response signal from the product tag, wherein the response signal comprises the generated code;
applying the algorithm to the code basis to produce an expected value; and
determining that the product is genuine if the expected value and the generated code are the same.

26. The method of claim 25 further comprising determining that the product is counterfeit if the expected value and the generated code are different.

27. The method of claim 25, wherein the product is selected from the group consisting of a good and a unit of currency.

28. The method of claim 25, wherein the code basis is selected from the group consisting of a manufacturer identifier associated with the product tag and a product serial number.

29. The method of claim 25 further comprising:
maintaining a datastore of previously received generated codes; and determining whether the a currently generated code is the same as a previously received generated code.

30. The method of claim 25, wherein the product tag comprises a memory slot for storing a counter value, wherein the response signal further comprises the counter value and wherein the method further comprises:
receiving the counter value from the product tag;
incrementing the counter value by one; and
storing the incremented counter value in counter value memory slot.

31. The method of claim 26, wherein the product tag further comprises a memory slot for storing a location value, wherein the response signal further comprises the location value, and wherein the method further comprises:
receiving a location value from the product tag;
replacing the location value with a current location value, and
storing the current location value in location value memory slot.

32. The method of claim 27, wherein the location value and the current location value are selected from the group consisting of factory, transit, storage, and received.

33. A method for product authentication comprising:
applying a first product tag to a first product and a second product tag to a second product, wherein the first product tag comprises a first memory slot for receiving a first generated code and wherein the second product tag comprises a second memory slot for receiving a second generated code;
generating the first generated code by applying an algorithm to a first code basis and generating the second generated code by applying an algorithm to a second code basis;
storing the first generated code in the first memory slot of the first product tag; storing the second generated code in the second memory slot of the second product tag;
transmitting an interrogation signal to the first and second product tags;
receiving a first response signal from the first product tag, wherein the first response signal comprises the first generated code;
receiving a second response signal from the second product tag, wherein the second response signal comprises the second generated code;
applying the algorithm to the first code basis to produce a first expected value and applying the algorithm to the second code basis to produce a second expected value;
determining that the first product is genuine if the first expected value and the first generated code of are the same; and
determining that the second product is genuine if the second expected value and the second generated code are the same.

34. The method of claim 33, wherein the first code basis and second code basis are selected from the group consisting of a manufacturer identifier associated with the product tag and a product serial number.

35. The method of claim 33 further comprising:
determining that the first product is counterfeit if the first expected value and the first generated code are different; and
determining that the second product is counterfeit if the second expected value and the second generated code are different.

36. The method of claim 33 further comprising:
maintaining a database of previously received generated codes; and
determining whether the first and second generated codes are the same as a previously received generated code.

37. The method of claim 33, wherein the first and second response signals are separated in a time domain.

38. The method of claim 33, wherein the first and second response signals are separated in a frequency domain.

39. A method for product authentication comprising:
applying a first product tag to a first product and a second product tag to a second product, wherein the first product tag comprises a first memory slot for receiving a first generated code and wherein the second product tag comprises a second memory slot for receiving a second generated code;
generating the first generated code by applying an algorithm to a first code basis and generating the second generated code by applying an algorithm to a second code basis;
storing the first generated code in the first memory slot of the first product tag; storing the second generated code in the second memory slot of the second product tag;
transmitting a first interrogation signal;
receiving a first response signal from the first product tag and a second response signal from the second product tag;
obtaining the first generated code from the first product tag;
transmitting a second interrogation signal;
receiving a first response signal from the first product tag and a second response signal from the second product tag; and
obtaining the second generated code from the second product tag.

40. A method for product authentication comprising:
applying a first product tag to a first product and a second product tag to a second product, wherein the first product tag comprises a first memory slot for receiving a first generated code and wherein the second product tag comprises a second memory slot for receiving a second generated code;
generating the first generated code by applying an algorithm to a first code basis and generating the second generated code by applying an algorithm to a second code basis;
storing the first generated code in the first memory slot of the first product tag; storing the second generated code in the second memory slot of the second product tag;
transmitting a first interrogation signal;
receiving a first response signal from the first product tag and a second response signal from the second product tag;
obtaining the first generated code from the first product tag;
barring the first product tag from responding to a second interrogation signal for a preset time interval;
transmitting a second interrogation signal;
receiving a second response signal from the second product tag;
obtaining the second generated code from the second product tag.

41. A system for authenticating a product comprising:
a product tag, wherein the product tag comprises a memory slot for receiving a generated code;
a processor adapted for:
generating the generated code by applying an algorithm applied to a code basis; and
storing the generated code in the memory slot of the product tag; and
an interrogator, wherein the interrogator is adapted for:
transmitting an interrogation signal to the product tag;
receiving a response signal from the product tag, wherein the response signal comprises the generated code;
applying the algorithm to the code basis to produce an expected value; and
determining that the product is genuine if the expected value and the generated code are the same.

42. The system of claim 41, wherein the interrogator is further adapted for determining that the product is counterfeit if the expected value and the generated code are different.

43. The system of claim 41, wherein the code basis is selected from the group consisting of a manufacturer identifier associated with the product tag and a product serial number.

44. The system of claim 41 further comprising a datastore, wherein the datastore comprises previously received generated codes, and wherein the interrogator is further adapted for determining whether the generated code is the same as a previously received generated code.

45. The system of claim 41, wherein the product tag further comprises a memory slot for storing a counter value, wherein the response signal further comprises the counter value and wherein the interrogator is further adapted for:
receiving the counter value from the product tag;
incrementing the counter value by one; and
storing the incremented counter value in counter value memory slot.

46. The system of claim 41, wherein the product tag further comprises a memory slot for storing a location value, wherein the response signal further comprises the location value, and wherein the interrogator is further adapted for:
receiving a location value from the product tag;
replacing the location value with a current location value, and
storing the current location value in location value memory slot.

47. The system of claim 46, wherein the location value and the current location value are selected from the group consisting of factory, transit, storage, and received.

48. The system of claim 41, wherein the product tag further comprises a memory slot for storing a counter value and a memory slot for storing a location value, and w herein the response signal further comprises the counter value and the location value, where in the system further comprises a central datastore, and wherein the interrogator is further adapted for:
receiving the counter value from the product tag;
incrementing the counter value by one;
storing the incremented counter value in counter value memory slot.
receiving a location value from the product tag;
replacing the location value with a current location value;
storing the current location value in location value memory slot; and
sending the counter value, the location value, and the generated code to the central datastore.
